(19) United States
(12) Patent Application Publication
(10) Pub. No.: US 2005/0050213 A1
(43) Pub. Date: Mar. 3, 2005

(54) Authorizing network requests

(76) Inventors: James Clough, Boise, ID (US); Darrel Cherry, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/653,787

(22) Filed: Sep. 3, 2003

(51) Int. Cl. G06F 15/16; H04L 9/32

(52) U.S. Cl. 709/229; 713/201

(57) ABSTRACT

A network request is routed though a network infrastructure to a network device. To make a determination of whether to accept or reject the network request, a network address from which the network request originated is identified by communicating with the network infrastructure. The network request is accepted only upon a determination that the identified network address is authorized.

### BACKGROUND

Printing solutions developed for public venues such as hotels and coffee shops provide customers with access to shared printers. A venue can set its own printing policies and implement its own printing related services. For example, a hotel may have a policy to charge its customers five cents for each page printed. The hotel may provide a service that allows a customer to specify that printed documents are to be delivered to the customer's room or held at the front desk to be picked up.

Consequently, there is a need for a solution that will allow a venue to restrict access to a shared printer allowing access to authorized venue customers. Existing solutions include requiring customers to supply a username and password. However, this requires customers to establish an account before they can use the printer. Another solution involves requiring venue customers to supply payment information such as a credit card number with each request to use the printer. This doesn't allow for cash payments and it does not allow a venue such as a hotel to include printer use fees with the customer's room bill.

### DESCRIPTION OF THE DRAWINGS

FIG. 1 illustrates an exemplary network in which embodiments of the present invention can be implemented.

FIG. 2 is a schematic representation of the program elements operating on the devices of FIG. 1 according to an embodiment of the present invention.

FIG. 3 is an exemplary table illustrating policy data according to an embodiment of the present invention.

FIG. 4 is an exemplary flow diagram illustrating steps taken to practice an embodiment of the present invention.

### DETAILED DESCRIPTION

Glossary:

Program: An organized list of electronic instructions that, when executed, causes a device to behave in a predetermined manner. The term program is both singular and plural in nature. A program can take many forms. For example, it may be software stored on a computer's disk drive. It may be firmware written onto read-only memory. It may be embodied in hardware as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components.

Client-Server: A model of interaction between two programs. For example, a program operating on one network device sends a request to a program operating on another network device and waits for a response. The requesting program is referred to as the “client” while the device on which the client operates is referred to as the “client device.” The responding program is referred to as the “server,” while the device on which the server operates is referred to as the “server device.” The server is responsible for acting on the client request and returning the requested information, if any, back to the client. This requested information may be an electronic file such as a word processing document or spread sheet, a web page, or any other electronic data to be displayed or used by the client. In any given network there may be multiple clients and multiple servers. A single device may contain a program or programs allowing it to operate both as a client device and as a server device. Moreover, a client and a server may both operate on the same device.

Web Server: A server that implements HTTP (Hypertext Transport Protocol). A web server can host a web site or a web service or both. A web site provides a user interface by supplying web pages to a requesting client, in this case a web browser. Web pages can be delivered in a number of formats including, but not limited to, HTML (Hyper-Text Markup Language) and XML (extensible Markup Language). Web pages may be generated on demand using server side scripting technologies including, but not limited to, ASP (Active Server Pages) and JSP (Java Server Pages). A web page is typically accessed through a network address. The network address can take the form of an URL (Uniform Resource Locator), IP (Internet Protocol) address, or any other unique addressing mechanism. A web service provides a programmatic interface that may be exposed using a variety of protocols layered on top of HTTP, such as SOAP (Simple Object Access Protocol).

Network Device: A device equipped to be accessed remotely over a network. Common examples include printers, scanners, and routers. However, other common household appliances such as refrigerators, microwaves, televisions, stereos, and home security systems can be network devices if properly equipped.

INTRODUCTION: Embodiments of the present invention operate to restrict access to a network device. Upon receiving a network request directed to the device, the network address from which the request originated is identified. If that address is identified as an address from which requests are to be allowed, the request is accepted. Otherwise, the request is rejected.

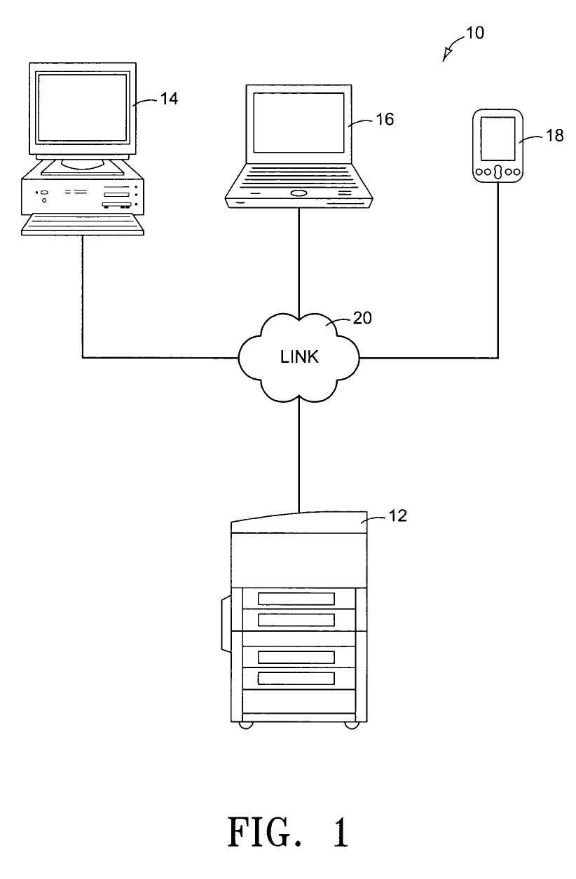

FIG. 1 illustrates an exemplary network 10 in which various embodiments of the present invention may be implemented. Network 10 includes network device 12, and computers 14-18. Network device 12 and computers 14-18 are interconnected by link 20. While network device 12 is shown as a printer, network device 12 may be any device equipped to communicate over network 10. Similarly, computers 14 and 16 can be any type of computing devices equipped to communicate over network 10 and make requests of network device 12. Link 20 represents generally any cable, wireless, or remote connection via a telecommunication link, an infrared link, a radio frequency link, or any other connector or system that provides electronic communication between network device 12 and computers 14-18. Link 20 represents the infrastructure of network 10 and includes one or more servers, switches, routers, and/or hubs that operate to direct network traffic between computers 14-18 and network device 12.

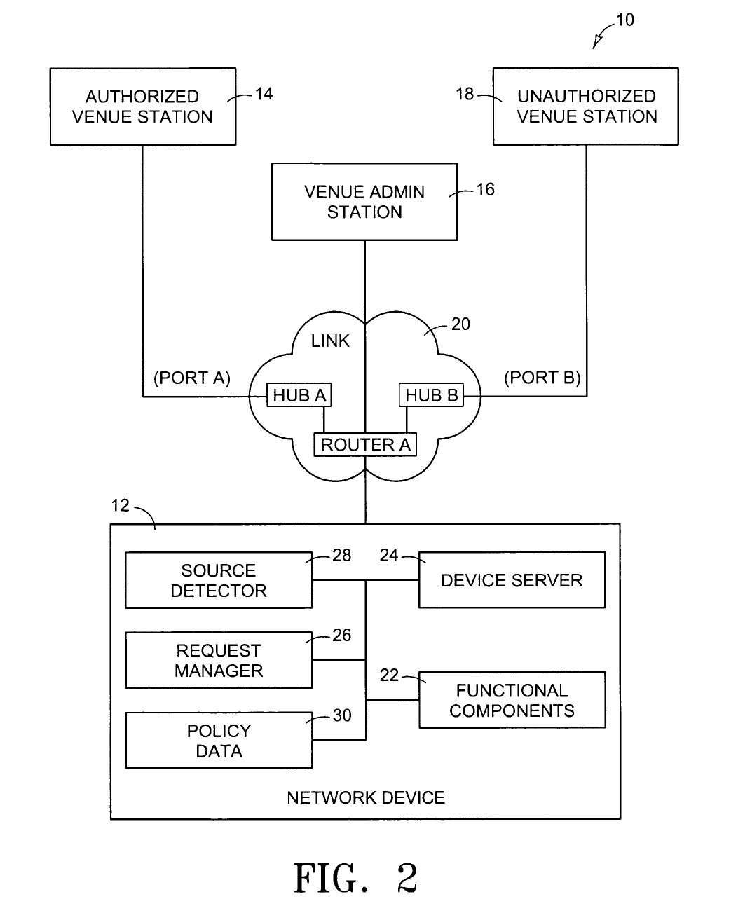

COMPONENTS: FIG. 2 is a schematic representation of network 10 illustrating the program elements operating on network device 12. Network device 12 includes functional components 22, device server 24, request manager 26, source detector 28, and policy data 30. While policy data 30, source detector 28, and request manager 26 are shown as being embedded on network device 12, it is noted that one or more of those components may be provided by a device other than network device 12.

Functional components 22 represent the hardware and/or programs for performing the functions for which network device 12 is intended. For example, where network device 12 is a printer or other image forming device, functional components 22 are those components responsible for producing a printed image on paper or other print media. Where network device 12 is a refrigerator, functional components 30 are those components responsible for keeping food cold.

Device server 24 represents generally any program capable of receiving network requests from computers 14-18 directed to network device 12. A network request directed to network device 12 is a request to utilize a function provided by network device 12. For example, where network device 12 is a printer, a network request can be instructions to print a document. Where for example, a network device is a stereo, a network request can be an instruction to play a specified track on a particular compact disc. Functional components 22 are responsible for acting on a network request.

Request manager 26 represents generally any program capable of determining whether to accept or reject a network request received by device server 24. Accepting a network request involves allowing or otherwise directing functional components 22 to act on the network request. Rejecting a network request involves preventing functional components 22 from acting on a network request.

Source detector 28 represents generally any program capable of identifying a network address from which a network request originated. Computers 14-18 are each assigned their own network address. A network address can be a MAC (Media Access Control) address, IP (Internet Protocol) address, or any other format that uniquely identifies a device on network 10. For example, a network address can be data identifying a port on a particular hub, router, or server through which the device is connected to network 10. The connection can be physical or wireless. In the example of FIG. 2, computer 14 (labeled “Authorized Venue Station”) is connected to port A of hub A used by link 20. Computer 18 (labeled “Unauthorized Venue Station”) is connected to port B of hub B. The network address “port A, hub A” can be used to identify computer 14. The network address “port B, hub B” can be used to identify computer 18. Source detector 28 may perform its task by communicating with network infrastructure hardware such as the servers, routers, hubs, and/or switches used by link 20 to learn the identity of a port through which a network request originated.

A network address identifying a port (port address) through which a connection can be made with a given network typically remains constant regardless of the device used to make the connection. IP addresses, however, are often not static. A MAC address remains constant so long as the same device is always used to make a connection to the network. Imagine a venue such as a hotel with data ports connecting each room to the hotel's network. A hotel guest with her own portable computer can connect to a port in her room. Each time the guest turns on her computer, she is assigned a new IP address. Her MAC address is dictated by her computer's network card. Without requesting information from the guest, the hotel will not be able to associate the guest's MAC or IP address with the guest. The one address known to the hotel without acquiring any information from the guest is the port address for the guest's room.

Policy data 30 represents generally any electronic data that can be used by request manager 26 to make a determination of whether to accept or reject a network request. For example, policy data may include a list of authorized network addresses. Request manager 26, then, only accepts network requests originating from a network address identified by policy data 30. Network request originating from a network address not identified by policy data 30 are rejected.

In the example of FIG. 2, policy data 30 contains the network address for computer 14—the authorized venue station. Policy data 30 does not contain the network address of computer 18—the unauthorized venue station. Consequently, network requests from computer 14 are accepted, and network requests from computer 18 are rejected.

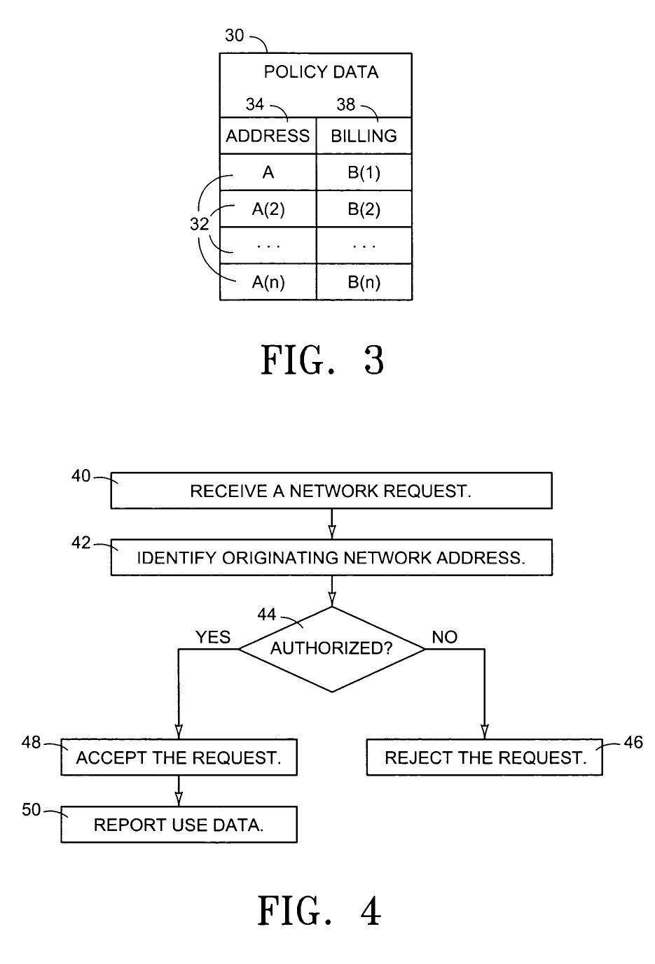

FIG. 3 illustrates policy data 30 in the form of a table. As shown, policy data table 30 includes a number of entries 32. Each entry includes an address field 34 and a billing field 38. The address field 34 of each given entry 32 contains data identifying a network address from which network requests will be accepted. The billing field 38 of a given entry 32 contains data identifying how charges are to be made.

For example, where network 10 of FIGS. 1 and 2 is located in a hotel, a user may be a hotel guest. The data in address field 34 of an entry 32 identifies the network address such as a port address associated with the guest's room. Data in billing field 38 identifies how charges are to be made for the use of network device 12. Data in billing field 38 might indicate that the a charge is to appear on a bill for a particular room associated with the network address, or it may indicate that a charge is to made to a credit card or prepaid account corresponding to a room associated with the network address. Where the network device is a printer, data in billing field may also indicate a specified price per page.

The block diagram of FIG. 2 shows the architecture, functionality, and operation of an embodiment of the present invention. Each block may represent in whole or in part a module, segment, or portion of code that comprises one or more executable instructions of a program or programs for implementing the specified logical function(s). Each block may represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, infrared, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

OPERATION: Exemplary steps taken to practice the invention are described with reference to FIG. 4. A network request is received (step 40). A port address or other suitable network address from which the network request originated is identified (step 42). It is determined whether the identified network address is authorized (step 44). If not authorized, the network request is rejected (step 46). If authorized, the network request is accepted (step 48), and use data is reported (step 50). Use data is data that in some manner indicates that a network request received in step 40 originating from an address identified in step 42 has been accepted in step 48 and acted upon by a network device. Use data can include or be based on billing information—information identifying or otherwise usable to identify a fee to be charged for acting on a network request as well as a manner in which the fee is to be charged.

Using FIG. 2 as an example, the steps shown in FIG. 4 are explained in more detail. Assume that network 10 is located in a venue such as a coffee shop. Network device 12 is a printer. The network infrastructure of link 20 includes hubs A and B and router A. Computer 14 is connected to network 10 through port A on hub A. Computer B is connected to port B on hub B. The port address corresponding to port A on hub A is authorized for sending print requests to network device 12. The port address corresponding to port B on hub B is not authorized to send print requests to network device 12.

Coffee shop customers send print requests from computers 14 and 1 8 to network device 12. Device server 24 receives those requests in step 40. Source detector 28 communicates with the network infrastructure, namely router A, hub A, and hub B of link 20, to identify the port addresses from which each of the requests originated in step 42. With the port addresses identified, request manager 26, in step 44, accesses policy data to determine if those port addresses are authorized. Request manager 26 determines that the port address for computer 18 is not authorized and rejects that request in step 46. Request manager 26, locating an entry 32 in policy data 30 containing data identifying port A hub A, determines that the port address for computer 14 is authorized and accepts that request in step 48. Functional components 22 act on the request and print a document.

In step 50, request manager 26 reports that the print request for the customer using computer 14 has been accepted and printed. Referring to FIG. 3, policy data 30 includes an entry 32 with an address field 34 identifying a network address for computer 14, in this case, “port A of hub A.” That entry 32 also includes billing field 38 containing data indicating how the coffee shop's customer using computer 14 is to be billed. For example, the customer may have an open tab. The data in billing field 38, then, may then indicate that customer is to be charged twenty cents for each printed page. In step 50, request manager 26 obtains this billing information from policy data 30, counts the number of printed pages and reports use data identifying, in this example, the number of printed pages and the price per page, to computer 16—labeled “Venue Admin Station” in FIG. 2. A computer program operating on computer 1 6 or a coffee shop employee monitoring computer 1 6 can, with the reported use data, add a printing charge to the customer's tab.

CONCLUSION: The present invention has been shown and described with reference to the foregoing exemplary embodiments. It is to be understood, however, that other forms, details, and embodiments may be made without departing from the spirit and scope of the invention that is defined in the following claims.

1. A method for authorizing a network request, the request routed though a network infrastructure to a network device, comprising:
communicating with the network infrastructure to identify a network address from which the network request originated; and
accepting the network request only upon a determination that the identified network address is authorized.

2. The method of claim 1, wherein communicating comprises communicating with the network infrastructure to identify a port from which the network request originated.

3. The method of claim 1, wherein the acts of communicating and accepting are performed by the network device.

4. The method of claim 1, further comprising reporting use data upon accepting the network request.

5. The method of claim 1, further comprising accessing policy data to determine if the identified network address is authorized.

6. The method of claim 1, further comprising:
accessing policy data specifying authorized network addresses and billing information for one or more authorized network address;
recognizing the identified network address as an authorized network address specified by the policy data and obtaining billing information for the identified network address; and
reporting use data based on the obtained billing information.

7. A method for printing comprising:
receiving a print request routed through a network infrastructure;
communicating with the network infrastructure to identify a network address from which the print request originated;
determining if the identified network address is authorized; and
acting upon the print request only if the identified network address is determined to be authorized.

8. The method of claim 7, wherein communicating comprises communicating with the network infrastructure to identify a port from which the network request originated.

9. The method of claim 7, wherein the acts of receiving, communicating, and determining are all performed by a printing device responsible for acting on the print request.

10. The method of claim 7, further comprising reporting use data if the print request is acted upon.

11. The method of claim 7, wherein determining comprises accessing policy data specifying authorized network addresses, and searching the policy data for the identified network address.

12. The method of claim 11, wherein determining further comprises recognizing the identified network address as an authorized network address specified by the policy data, and wherein the policy data includes billing information for the identified network address, the method further comprising reporting use data based upon the billing information.

13. A computer readable medium having instructions for:
communicating with a network infrastructure through which a network request was routed to identify a network address from which the network request originated; and
accepting the network request only upon a determination that the identified network address is authorized.

14. The medium of claim 13, wherein the instruction for communicating include instructions for communicating with the network infrastructure to identify a port from which the network request originated.

15. The medium of claim 13, having further instructions for reporting use data upon accepting the network request.

16. The medium of claim 13, having further instructions for accessing policy data to determine if the identified network address is authorized.

17. The medium of claim 13, having further instructions for:
accessing policy data specifying authorized network addresses and billing information for one or more authorized network address;
recognizing the identified network address as an authorized network address specified by the policy data and obtaining billing information for the identified network address; and
reporting use data based on the obtained billing information.

18. A computer readable medium having instructions for receiving a print request routed through a network infrastructure;
communicating with the network infrastructure to identify a network address from which the print request originated;
determining if the identified network address is authorized; and
acting upon the print request only if the identified network address is determined to be authorized.

19. The medium of claim 18, wherein the instruction for communicating include instructions for communicating with the network infrastructure to identify a port from which the network request originated.

20. The medium of claim 18, having further instructions for reporting use data if the print request is acted upon.

21. The medium of claim 18, wherein the instructions for determining include instructions for accessing policy data specifying authorized network addresses and searching the policy data for the identified network address.

22. The medium of claim 21, wherein the identified network address is recognized as an authorized network address specified by the policy data, and wherein the policy data includes billing information for the identified network address, the medium having further instructions for reporting use data based upon the billing information.

23. A system for authorizing a network request, the request routed though a network infrastructure to a network device, comprising:
a source detector operable to communicate with the network infrastructure to identify a network address from which the network request originated; and
a request manager operable to accept the network request only upon a determination that the identified network address is authorized.

24. The system of claim 23, wherein the a source detector is operable to communicate with the network infrastructure to identify a port from which the network request originated.

25. The system of claim 23, wherein the source manager is operable to report use data upon accepting the network request.

26. The system of claim 23, wherein the source manager is operable to access policy data to determine if the identified network address is authorized.

27. The system of claim 23, wherein the request manager is operable to:
access policy data specifying authorized network addresses and billing information for one or more authorized network address;
recognize the identified network address as an authorized network address specified by the policy data and obtain billing information for the identified network address; and
report use data based on the obtained billing information.

28. The system of claim 23, wherein the source detector and the request manager are embedded in a network device.

29. A network printing device, comprising:
functional components operable to act on a print request;
a device server operable to receiving a print request routed through a network infrastructure;
a source detector operable to communicate with the network infrastructure to identify a network address from which the print request originated; and
a request manager operable to determine if the identified network address is authorized and to direct the functional components to act upon the print request only if the identified network address is determined to be authorized.

30. The device of claim 29, wherein the request manager is operable to report use data if the print request is acted upon.

31. The device of claim 29, wherein the source detector is operable to determine if the identified network address is authorized by accessing policy data specifying authorized network addresses and searching the policy data for the identified network address.

32. The device of claim 31, wherein, upon recognizing the identified network address as an authorized network address specified by the policy data, and wherein the policy data includes billing information for the identified network address, the request manager is operable to report use data based upon the billing information.

33. A system for authorizing a network request, the request routed though a network infrastructure to a network device, comprising:
a means for communicating with the network infrastructure to identify a network address from which the network request originated; and
a means for accepting the network request only upon a determination that the identified network address is authorized.

34. A network printing device, comprising:
functional components operable to act on a print request;
a means for receiving a print request routed through a network infrastructure;
a means for communicating with the network infrastructure to identify a network address from which the print request originated; and
a means for determining if the identified network address is authorized and to direct the functional components to act upon the print request only if the identified network address is determined to be authorized.
